(19) United States
(12) Patent Application Publication
(10) Pub. No.: US 2013/0100884 A1
(43) Pub. Date: Apr. 25, 2013

(54) Wireless Gateway

(71) Applicants: Dennis J. KING, Elk Grove, CA (US); Mark N. Rosen, Auburn, CA (US); Wojciech B. Lewalski, Cool, CA (US)

(72) Inventors: Dennis J. KING, Elk Grove, CA (US); Mark N. Rosen, Auburn, CA (US); Wojciech B. Lewalski, Cool, CA (US)

(21) Appl. No.: 13/527,971

(22) Filed: Jun. 20, 2012

Related U.S. Application Data
(63) Continuation of application No. 13/310,686, filed on Dec. 2, 2011, now abandoned.
Application No. 13/310,686 is a continuation of application No. 12/880,963, filed on Sep. 13, 2010, now abandoned.
Application No. 12/880,963 is a continuation of application No. 12/484,873, filed on Jun. 15, 2009, now abandoned.
Application No. 12/484,873 is a continuation of application No. 11/548,667, filed on Oct. 11, 2006, now abandoned.

(51) Int. Cl. H04W 88/16

(52) U.S. Cl. CPC H04W 88/16
USPC 370/328

(57) ABSTRACT

The present invention provides a wireless gateway, having a base interface unit and at least one communication device connected to the base interface unit. The gateway further includes a first transceiver cartridge removeably connected to the base interface unit. The first transceiver cartridge is operably configured to enable the communication device access to a first wireless network. A second transceiver cartridge is removeably connected to the base interface unit, wherein the second transceiver cartridge is operably configured to enable the at least one communication device access to a second wireless network. The gateway also includes an antenna combiner connected to the base interface unit and it is operably configured to transmit and receive signals for the first and second transceiver cartridges.

### RELATED APPLICATIONS

This continuation application claims the benefit of application Ser. No. 13/310,686, filed on Dec. 2, 2011; Ser. No. 12/880,963, filed Sep. 13, 2010; Ser. No. 12/484,873, filed Jun. 15, 2009; Ser. No. 11/548,667, filed Oct. 11, 2006; 61/061,591, filed Jun. 13, 2008; 61/061,613, filed Jun. 14, 2008; and, 60/725,735 filed Oct. 11, 2005, all of which are incorporated herein by reference in their respective entireties, and all of to which priority is claimed.

### BACKGROUND OF THE INVENTION

1. Field of Invention

The present invention relates to a wireless modular gateway system.

2. Description of Related Art

The demands of having continuous access to communication devices and services is ever increasing. There are many scenarios where a workgroup of communication users require shared use of communication services, such as voice, fax and data. An example of such a scenario includes a normal business workplace atmosphere in an office building or the like. Other example scenarios include a temporary placement of a workgroup where installing conventional landlines are not available or are too costly. Another scenario can occur when there is cellular or landline disruption.

Conventional devices and systems that may assist a workgroup of communication users in these types of scenarios are wide and varied and include such things as conventional landlines, handsets and pc cards, fixed cellular terminals, routers, and point to point radio systems. However, conventional devices and systems fail to be both simple and dynamic, in that it is simple to install and get up and running, while also being dynamic enough to work on and easily switch between multiple networks.

A further deficiency inherent with conventional solutions is the inability to easily upgrade as cellular network technology is advanced.

Another deficiency with conventional solutions is their limited ability to conduct data and voice transmissions simultaneously. Since conventional solutions generally have access to only one wireless network, such multi-tasking ability is unavailable.

### SUMMARY OF THE INVENTION

The present invention overcomes the drawbacks and shortcomings of conventional wireless communication devices. The present invention is a system that is highly adaptable and scalable communications architecture allowing a variety of analog or digital peripheral devices to access wired or wireless networks. The present invention includes a gateway that provides a consistent communications platform for one or more wireless uplinks, regardless of the networks used through a modular approach using transceiver cartridges, and optionally the ability to connect with one or more public switched telephone network (PSTN).

The present invention is similar to and contains many of the same features and methods as disclosed in U.S. Publication No. US-2007-0135120, published on Jun. 14, 2007 and in the name of the same inventors of the present invention. U.S. Publication No. US-2007-0135120 is incorporated, in its entirety, herein by reference.

The present invention is designed to provide the user with greater flexibility resulting in increased functional capabilities and a least cost method to change service providers, change network platforms and to easily upgrade the device. Conventional devices and systems require the entire unit to be replaced in order to change or add networks or to upgrade the device.

The present system utilizes a unique base unit or host device that receives a plurality of removable and interchangeable transceiver cartridges. Each of the transceiver cartridges contains a cellular transceiver and essential control circuitry. The base unit includes a main circuit board configured with control, processing and routing circuitry and firmware designed to allow access and control of the transceiver cartridge control circuitry. The base unit also includes support components such as antenna combiners and a power supply to provide power to the transceiver cartridge. The base unit further includes application interfaces for the workgroup. The cartridges are preferably installed in a protective plastic casing designed to be inserted into a base interface unit, wherein terminals of the cartridges engage a socket on the base unit, which provides a connection to the main circuit board of the base unit.

The present invention provides a communications platform wherein a base unit that receives network transceiver cartridges, operates as a switch, connecting one or more users with one or more networks. The base unit provides for the flow, conversion and combining of circuit-switched (analog signals) and packet-switched (digital data) communication traffic.

Some of the primary features of present invention are: the device can be used with any combination of a plurality of transceiver cartridges and a plurality of telephone service lines; the device can be used on a variety of network platforms or service providers at the same time; the device provides a least cost upgrade method by requiring only the transceiver cartridge to be replaced; and, the device when installed in an optional wall mount bracket will provide a fail safe (power off) connection to a standard wire line telephone service hard wired between building telephone service entrance and building telephone wiring.

Additionally, in a preferred embodiment, a device is provided such that a user may select a type of service priority for automatic line number assignment for standard wire line telephone service, cellular service or cellular back-up for wire line service by a manual switch. The Fixed Cellular Terminal device made in accordance with the present invention also allows common nine pin (DB-9) connectors, universal serial bus (USB) 2.0 and RJ-45 data connectors to support the “always on” capabilities of third generation (broadband) cellular technology deployed by network providers.

The present invention is a device for providing a gateway between a public switching telephone network and a plurality of cellular networks. The device of the present invention comprises a controller interface including telephony circuitry, power circuitry, and a master cellular phone circuitry. The controller may optionally be connected to at least one public switching network. Additionally, the controller interface includes a plurality of cartridge slots connected to the telephony circuitry and the master cellular phone circuitry, wherein the telephony circuitry links the master cellular phone circuitry to the public switching telephone network. Further the present invention includes at least one transceiver cartridge removeably connected to one of the cartridge slots of the controller interface. The transceiver cartridge is operably configured to wirelessly link the master cellular phone circuitry to the cellular networks via an antenna. The device further includes an output from the controller interface; an input to the controller interface; a user mode select switch disposed on the controller unit; a power supply connected to the power circuitry of the controller interface; and, an antenna assembly connected to the antenna circuitry of the controller interface, wherein the controller interface circuitry is operably configured to switch between land line telephone network and the plurality of cellular networks based on preset conditions.

The present invention further discloses a transceiver cartridge device comprising a housing; a cellular phone circuitry disposed within the housing; and, a connecting terminal operably configured to engage the controller interface; wherein the transceiver cartridge device is operably configured to engage a controller interface operably configured to receive the transceiver cartridge.

Still, another aspect of the present invention discloses a fixed cellular terminal (gateway) system, wherein the system includes a fixed cellular terminal (FCT), wherein the FCT includes a controller interface including telephony circuitry, power circuitry, and a master cellular phone circuitry, the controller being connected to at least one public switching network. The controller interface further includes a plurality of cartridge slots connected to the telephony circuitry within the base unit. The device further includes a public switching telephone network connection; a cellular transceiver cartridge, wherein the cellular transceiver cartridge is removeably connected to the cartridge slots of the controller interface, the transceiver cartridges being operably configured to wirelessly link to the wireless networks associated with the respective cartridge; an antenna connected to the controller interface; a personal computer input within the controller interface; a primary electrical power supply connected to the controller interface; a backup electrical power supply within the controller interface; and, a standard landline phone handset connected to the controller interface.

These and other features and advantages of this invention are described in, or are apparent from, the following detailed description of various exemplary embodiments of the devices and methods according to this invention.

### BRIEF DESCRIPTION OF THE DRAWINGS

Various exemplary embodiments of this invention will be described in detail, with reference to the following figures, wherein:

FIG. 1 is a block diagram of a wireless gateway system made in accordance with the present invention; and,

FIG. 2 is a block diagram of a base interface unit made in accordance with the present invention.

### BRIEF DESCRIPTION OF APPENDICES

Various exemplary embodiments of this invention will be described in detail, with reference to the following appendices, wherein:

Appendix A is a description of a system overview of an exemplary embodiment of a wireless gateway system and methods made in accordance with the present invention (this appendix is attached as three parts A1, A2 and A3;

Appendix B is a description of exemplary embodiments for methods and software systems for operation of a wireless gateway made in accordance with the present invention;

Appendix C is a series of charts for another exemplary embodiment of methods, software design and user preferences for operation of a wireless gateway made in accordance with the present invention;

Appendix D is a description of another exemplary embodiment of a wireless gateway system and methods (trademarked “JOBLINK”), made in accordance with the present invention;

Appendix E is a description of yet another exemplary embodiment of a wireless gateway made in accordance with the present invention and comparisons with other conventional devices, systems and methods;

Appendix F is a set of figures of an exemplary embodiment of a wireless gateway system and base interface unit, made in accordance with the present invention;

Appendix G is a set of figures of an exemplary embodiment of a transceiver cartridge for use with a wireless gateway, made in accordance with the present invention; and,

Appendix H is a description of an exemplary embodiment of the integrated internal signal path routing for a wireless gateway system made in accordance with the present invention;

### DETAILED DESCRIPTION OF THE PREFERRED EMBODIMENTS

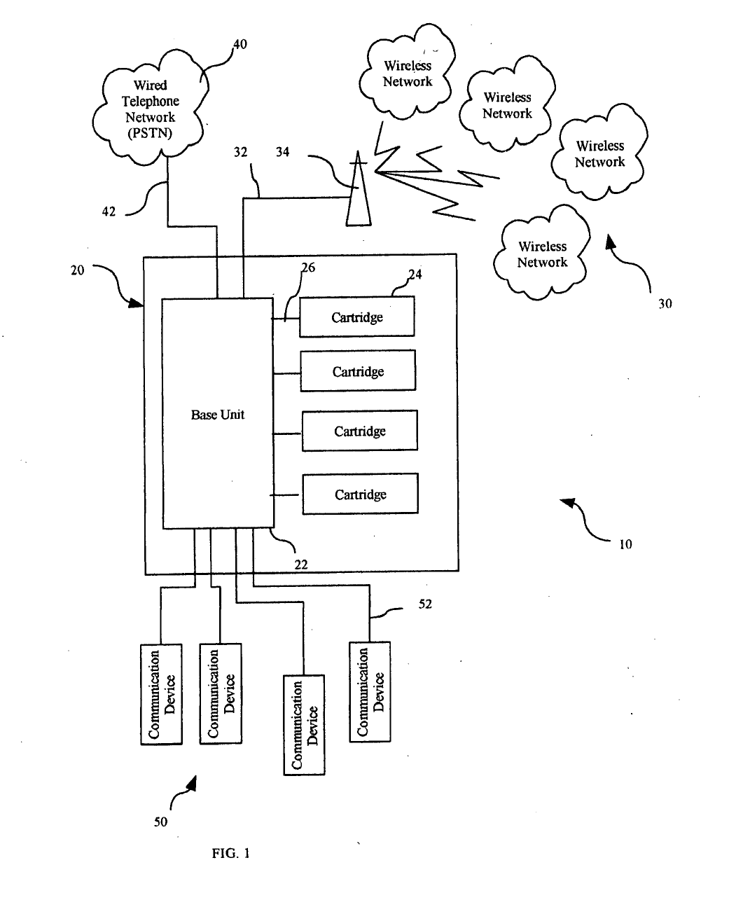

FIG. 1 is a block diagram of an exemplary embodiment of a communication system 10 in accordance with the present invention. The communication system 10 includes a wireless gateway 20, a plurality of wireless networks 30, a wired telephone network 40 and a plurality of wired devices 50.

The wireless gateway 20 includes a base unit 22 and a plurality of transceiver cartridges 24. The transceiver cartridges 24 are wireless transceiver cartridges for accessing and communicating with particular wireless networks. The cartridges contain necessary circuitry and data that the base unit will utilize to access the wireless networks 30. In this embodiment there are four transceiver cartridges 24. It should be appreciated that in other various exemplary embodiments any number of cartridges may be employed and even only one if desired by a user. The base unit communicates with each of the cartridges via links 26.

The base unit 22 includes necessary, power supply, circuitry, processors and memory to execute and control the communication from the wireless networks 30 and the wired network 40 to the wired devices 50. The base unit 22 contains all interface, control and power circuitry required and common to the operation of wireless transceiver cartridges developed and installed in the system including consideration for networks undeveloped or unknown at this time. The base unit manages the use of the multiple transceiver cartridges or wireless uplinks to achieve optimum traffic capacity given the networks available to it via the transceiver cartridges 24.

The plurality of wireless networks 30 are accessed by the base unit via link 32, which includes at least one antennae 34. The antennae communicate with each individual wireless network 30. The wireless networks 30 are any conventional wireless networks. Examples of some wireless networks are such as, but not limited to, code division multiple access networks (CDMA), global system for mobile communications networks (GSM), integrated digital enhance networks (iDEN), Wi-Fi, WiMax, personal communication service (PCS), cellular digital packet data (CDPD), general packet radio service (GPRS), wide area data networks, global positioning satellite signals (GPS), and satellite networks.

The wired telephone network 40 is any type of conventional wired telephone network, such as a public switched telephone network (PSTN).

The communication devices 50 are preferred to be wired devices such as analog or digital conventional phones, faxes and/or computers. It should be appreciated that in other exemplary embodiments some or all of the communication devices are cordless type devices such as a conventional cordless phone. The communication devices 50 are connected to the base unit via communication links 52. The communication devices 50 are the devices that will be used by users within an organization utilizing the gateway 20 to communicate with others.

The links 26, 32, 42 and 52 may be any type of links. The links may be any known or later developed links that provide for electronic communication between the linked components. The links can include wire, circuit board, infrared, radio frequency and the like.

In operation, the base unit 22 of the wireless gateway 20 functions as a switch. In essence, communications from one or more users must be connected with one or more available networks with which the gateway is in communication.

Among communications technologies there are a myriad of mediums, formats and protocols for transmitting information. There are many ways to group them, but a preferred way to organize them from a switching perspective is to ask whether they are commonly carried on circuit or packet-switched networks. Circuit-switched networks give a call or session a fixed allotment of “space” within the network, whether that space is a physical wire, a frequency band, or time slot. In packet-switched networks, each call or session is broken into packets of information which share the medium in a more flexible way. The packets include not only the conversation or data that the users are sending to each other, but labels that identify the users and other valuable information that characterize the connection.

In the gateway 20, circuit-switched (voice and analog POTS-compatible equipments such as fax machines) and packet-switched (digital data) traffic is efficiently connected from the users to the available networks. Circuit-switched signals and packet data meet within the base unit 22. The base unit 22 includes system resources and circuitry to allow native circuit-switched signals such as phone to cell network voice to traverse the base unit system with little intervention by the base unit. Similarly, digital data (e.g. from computers) is routed internally within the base unit by dedicated hardware and needs little attention. In the scenario of voice over internet protocol (VoIP), both the circuit-switched voice and packet-switched data are joined within a bridge created by a processing unit of the base unit.

The base unit 22 performs multiple functions as will be detailed further. The base unit is self configuring to meet the requirements for any new transceiver cartridges that may be connected to the gateway for communication with a wireless network. Further, the base unit allows the gateway to have simultaneous disparate network operation. Additionally, the base unit converts circuit-switched signals to packet-switched signals and vice versa. The base unit controls the functions of the various transceiver cartridges that may be in connected to the gateway 20, such as call set-up, termination for voice, fax or data calls. The base unit 22 also provides private branch exchange (PBX) capabilities. Such PBX capabilities includes for example: automatic network failover; automatic routing of call over network with lowest service cost; automatic routing to the network cartridge with the best data speed for internet access and data applications; automatic selection of best available wireless or wired network available to the system based on signal strength and service QOS; routing of outgoing calls on lines other than the primary line (Subscriber Line 1) to conserve traffic on the primary line/number for incoming calls; automatic drop of call in progress on Subscriber Line 1 and call routing to Cartridge Slot 1 for 911 calls (to meet federal E911 requirements); user line configuration for routing/priority configurations (automatic call forwarding to maintain incoming calls to primary number if one network lost; wireless back-up to wireline service; line assignments to individual rooms or locations; and, call restrictions and pass codes); and, distribution of VoIP services.

The transceiver cartridges 24 can, based upon the user's selection, be connected and disconnected from the base unit 22 at will. The transceiver cartridges provide a modular way of changing the systems radio frequency (RF) circuitry required to access the wireless networks on which the user wishes to operate. The present invention with modular transceiver cartridges provides the user with the ability to configure the entire system using RF frequencies and networks to meet their specific needs at the outset of use of the system and then change the configuration at will as the user's needs change without having to take the entire system out of service. The cartridges 24 can be any of the various cartridge embodiments described throughout this invention.

The gateway 20 has highly adaptable and scalable communications architecture allowing for a variety of analog or digital peripheral devices to access wired or wireless networks. The gateway 20 provides for a consistent communications platform for one or more wireless uplinks, regardless of network(s) used through a modular approach using transceiver cartridges designed specifically for interoperability with base interface unit as well as the optional ability to connect with one or more PSTN service lines.

The gateway 20 includes the necessary interface, control and power circuitry required and common to the operation of any wireless network transceiver cartridge developed and installed in the system. The gateway 20 is also operably configured to be adaptable to be compatible with networks undeveloped or unknown at this time. The primary function and focus of the gateway 20 is the management and efficient use of multiple wireless uplinks to achieve optimum traffic capacity given the network(s) available to it. The processing capacity and switching capability of the gateway 20 includes the flexibility to upgrade complete systems by the use of new cartridges, firmware or software to support future multimedia applications and provide the Quality of Service (QOS) afforded by future network upgrades/deployments and the IP multimedia subsystem (IMS). Furthermore, the basic architecture of the gateway 20 is highly scalable to support and manage a significant number of uplinks and user communication devices

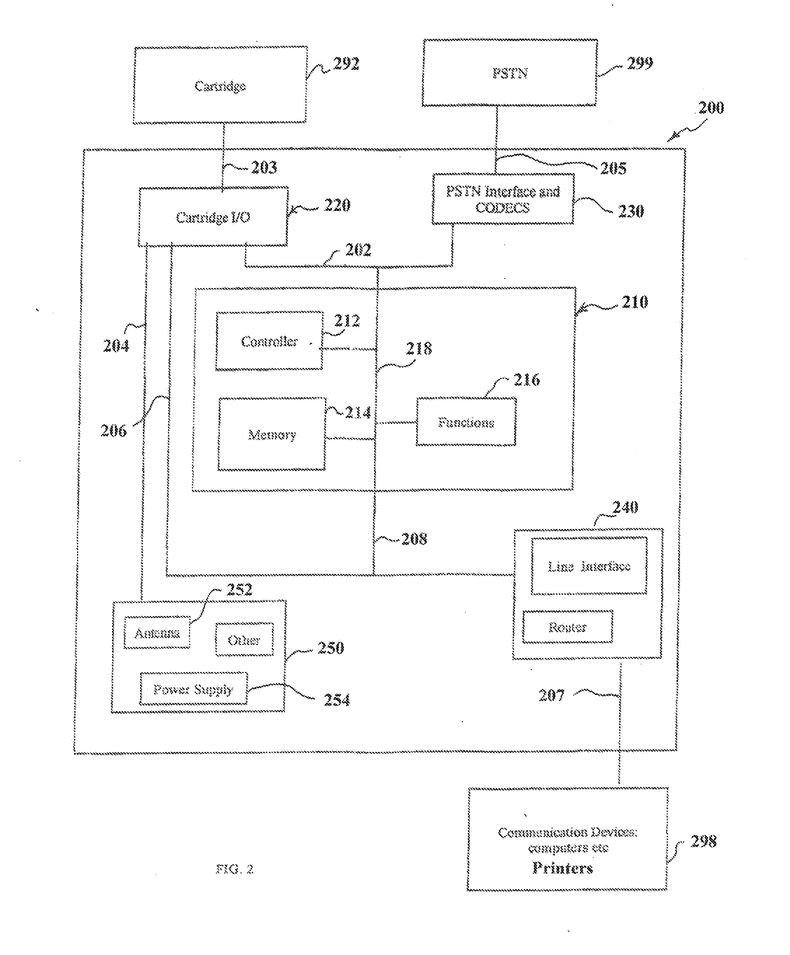

Referring to FIG. 2, a base interface unit (BIU) 200 is shown. The BIU 200 is an exemplary embodiment of a base interface unit, made in accordance with the present invention is shown. The BIU 200 may, for example, be utilized as the base unit 22 discussed above in connection with the communication system 10.

The BIU 200 preferably includes a control center 210, a cartridge input/output 220, a network interface 230, a user interface 240, and support components 250.

The BIU 200 is operably configured to connect to a variety of other components, such as but not limited to transceiver cartridges 292, communication devices 298 and a wired telephone network 299. The cartridges 292 are preferably similar to and have similar features to the cartridges 24 referenced above in connection with the system 10. The communication devices 298 are preferably similar to and have similar features to the communication devices 50 referenced above in connection with the system 10. The communication devices 298 can include a variety of conventional devices such as, but not limited to computer with input peripherals such as a keyboard and a mouse, as well as a monitor, pen tablets and printers. Further, the communication devices can, in one exemplary embodiment, be a flash memory card reader for reading flash memory cards (e.g. a secure digital memory card (SD Card)), having data stored thereon. Further, the wired telephone network 299 is preferably similar to and has similar features to the wired telephone network 40 referenced above in connection with the system 10.

The control center 210 includes a controller 212, memory 214, and functions 216. A control link 218 connects the controller 212 with the memory 214, and the circuits 216. It should be appreciated that the circuits may be combined or a part of the controller 212. The link 218 can be any known or later developed elements that are capable of transferring electronic signals between the components that are connected to the link.

The controller 212 can be any known or later developed processor. It is preferred that the controller 212 be a microcontroller with onboard memory. In some exemplary embodiments the controller is a plurality of controllers and of varying types. The controller 212 controls all aspects of the BIU configuration. The controller 212 also preferably establishes and terminates voice and data connections. The controller 212 further preferably monitors the status of the hardware of the BIU and the cartridges. The controller preferably includes a FPGA, which can be any know or later developed gate array. It should be appreciated that in some exemplary embodiments, the FPGA includes multiple FPGA's. The FPGA enables the ability to alter the flow of voice, fax, and data from the cartridges and through the BIU. The FPGA further enables multiplexers and clocked registers to be employed as needed to channel, shuffle and sequence serial and parallel data flowing through them. When the BIU is powered up, as will be discussed below, the controller 212 programs the internal gate arrangement within the FPGA to establish all the data path choices. The controller 212 can then select one or more of the paths through the FPGA with control pins rather than having to re-program the FPGA each time a pathway needs to be established or removed.

The memory 214 can be any known or later developed memory. It is preferred that the memory 214 be comprised of at least non-volatile memory and static or dynamic random access memory (RAM). However, it should be appreciated that the memory can also be implemented using a floppy disk and disk drive, a writeable optical disk and disk drive, a hard drive, or any combination of these elements. The memory 214 is used to store programs, firmware and data.

The functions 216 are tasks to be carried out by the controller 212 to operate the BIU. The functions 216 in this embodiment are program or software code that utilize and manipulate signals and data within the BIU and the Cartridges 292. It should be appreciated that the functions 216 could also be carried out through the use of circuits. It preferred that the functions 216 include a Call Management Function, a Voice Call Function, a Data Call Function and a Fax Call Function. The voice, data and fax call functions manage the voice, data and fax calls respectively, through the BIU. The Call Management Function will interact with the other functions in order to organize and handle voice, data and fax calls and to ensure that they navigate through the base interface unit to the intended communication device(s) 298 and corresponding cartridge(s) 292 or PSTN 299. It is preferred that the functions 216 further include a Board Support Function that communicates with Call Management Function. The Board Support Function constantly monitors all cartridge interfaces and communicates this information to the Call Management Function. The Call Management Function grants voice, data or fax enablement, to the Voice, Data and Fax Functions based on the information provided to the Call Management Function from the Board Support Function. It is further preferred that the functions 216 further include a Browser based configuration interface for user manipulation of the configurable BIU settings, such as line arrangements, least call routing and the like. The functions 216 is preferred to also include a Cartridge Application Programming Interface.

The cartridge input/output 220 is any known or later developed connection allowing electrical connection between the BIU and the cartridges. It is preferred that the cartridge input/output 22 include a plurality of connections, and further that the number of connections equal the number of cartridge slots that the BIU has. The connections enable the components of the BIU to communicate (i.e. send and receive electrical signals) with components of the cartridges. It is preferred that the cartridge input/output be operable configured to individually connect with multiple cartridges. It is preferred that the cartridge input/output 220 be part of a configuration of the BIU such that the cartridges can be easily plugged in and removed as desired by the user.

The network interface 230 is any known or later developed connection means allowing electrical connection between the BIU and a wired telephone network. It is preferred that the network interface 230 include a plurality of connections to all for a plurality of phone lines. An example of a known connection means is a standard RJ-11 phone jack. The network interface 230 preferably includes a codec functions for handling and converting the signals from the PSTN network.

The user interface connections 240 is any known or later developed connection means allowing electrical connection between the BIU and communication devices. For example the connections can be a USB, RS-232 or RJ-11 or RJ-45 type connections. It is preferred that the user interface connections include a plurality of connections. The communication devices are similar to the communication devices set forth above. The devices can include devices such as computers, with input and output devices, including printers, fax machines, wired phones, etc. The user may also configure the system by using the RJ-45 Ethernet connection for line assignments, least cost call routing and other custom call routing features, via HTML pages. The user interface preferably includes an integrated router to allow multiple computers to be connected to the BIU.

The support components 250 preferably include an antennae combiner 252 and a power supply 254. The antennae combiner 252 is any known or later developed means for transmitting and receiving multiple electrical signals through a single antenna. It should be appreciated that multiple antenna combiners may be utilized in other embodiments, such as for example to cover overlapping frequency ranges. The signals will come to and from the antennae and in to and out of the BIU through the antennae combiner. Having a antennae combiner allows the BIU to be attached to a single antennae. In essence the plurality of cartridges 292 will share a single antenna. It should be appreciated that multiple antennae could be employed so that each cartridge has its own antennae. The power supply 254 is preferably a rechargeable power supply. The power supply is operably configured to be connected to and be recharged from conventional electrical outlets. The power supply is operably configured to regulate and deliver the required voltage to the BIU. The required voltage is predetermined by the design components employed within the BIU.

200 includes buses or links 202, 203, 204, 205, 206, 207 and 208, which are any known or later developed means of passing signals between the components with which the links connect, including hard wire, radio frequency, integrated circuits and the like.

The BIU 200 in this embodiment is a wireless hub with the capabilities and functions of a FCT (Fixed Cellular Terminals), bridge or WLL (Wireless Local Loops). The BIU 200 is designed to provide connections for analog phone, fax and internet access for multiple users in a small office environment. The BIU is in essence a universal wireless communications hub or Network Interface Units (NIU) providing the user with an “all in one” or “whole office” solution for connection of multiple analog (circuit-switched) or digital (packet-switched) peripherals, including analog phones, fax machines, security systems and computers. The BIU 200 is operably configured to accommodate shared usage of voice, Fax and data services in a workgroup environment as opposed to an individual solution.

Referring to Appendix A, a description of a system overview of an exemplary embodiment of a wireless gateway system and methods associated therewith is disclosed. The embodiments shown in this description are illustrative and can be combined with other embodiments. Further, the gateway system disclosed in this appendix is an exemplary embodiment of the gateways 20 and 200 referenced above. The components, features, methods and software associated with this system can be utilized in other various exemplary embodiments with the above-noted gateways 20 and 200.

Referring to Appendix B, a description of an exemplary embodiment for methods and software systems for operation of a wireless gateway made in accordance with the present invention, is disclosed. The methods disclosed can be utilized with any of the gateway embodiments referenced by this invention. Further, it is preferred to be used with the embodiments disclosed in Appendix A. This Appendix B also includes references to components found in the embodiment disclosed in Appendix A.

Referring to Appendix C is a series of charts for an alternative exemplary embodiment of methods, software design and user preferences for operation of a wireless gateway made in accordance with the present invention. These embodiments may also be utilized in connection with any of the gateway embodiments made in accordance with the present invention.

Referring to Appendix D is a description of another exemplary embodiment of a wireless gateway system and methods (trademarked “JOBLINK”), made in accordance with the present invention. The embodiments disclosed in this appendix may be combined with any other embodiments of the present invention.

Referring to Appendix E is a description of how wireless gateway embodiments, made in accordance with the present invention compare to conventional devices, systems, solutions and methods.

Referring to Appendix F is a set of figures of an exemplary embodiment of a wireless gateway system and base interface unit, made in accordance with the present invention. The gateway disclosed in this Appendix is a preferred embodiment of the invention.

Referring to Appendix G is a set of figures of an exemplary embodiment of a transceiver cartridge for use with a wireless gateway, made in accordance with the present invention. The cartridge disclosed in this Appendix is a preferred embodiment of the invention and is utilized with the gateway disclosed in Appendix F. Note how the cartridge includes side tabs or protrusions that ensure proper alignment with the gateway when the cartridges are being installed. Further with the arrangement of the side tabs the cartridge can only be inserted within the gateway one way, thus ensuring proper connection alignment between the cartridge and the gateway.

Referring to Appendix H, disclosed is an exemplary embodiment of the integrated internal signal path routing for a wireless gateway system made in accordance with the present invention.

It should be appreciated that the present invention could be configured with different alternative embodiments. For example, the transceiver cartridges could be internally mounted to the base unit thereby requiring removal of the top of the base unit for the cartridges to be change. Another alternative exemplary embodiment could include a wireless Fidelity (WiFi) connection to a cellular phone and a computer. Further, in another alternative exemplary embodiment, the base unit could have two portions, wherein a first portion would contain the software to run and program the base unit and the second portion would contain the hardware and cartridges.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of this invention.

What is claimed is:

1. A wireless gateway, comprising:
a base interface unit;
at least one communication device connected to the base interface unit;
a first transceiver cartridge removeably connected to the base interface unit, the first transceiver cartridge being operably configured to enable the at least one communication device access to a first wireless network;
a second transceiver cartridge removeably connected to the base interface unit, the second transceiver cartridge being operably configured to enable the at least one communication device access to a second wireless network; and,
an antenna combiner connected to the base interface unit and operably configured to transmit and receive signals for the first and second transceiver cartridges.

2. The wireless gateway as recited in claim 1, wherein the transceiver cartridges are operably configured to transmit data.

3. The wireless gateway, as recited in claim 1, wherein the first wireless network is a cellular network.

4. The wireless gateway, as recited in claim 1, wherein the antenna combiner is disposed within the base interface unit.

5. The wireless gateway, as recited in claim 1, wherein the base interface unit is operably configured to select at least one of the first and second wireless networks for the at least one communication device to access based upon a cost rate for each of the first and the second wireless networks.

6. The wireless gateway, as recited in claim 1, wherein at least one of the first and second transceiver cartridges is selectively removable without interrupting access to the other of the first and second wireless network connections with the cat least one communication device.

7. The wireless gateway, as recited in claim 1, wherein the first and second wireless networks are the same wireless networks.
